(19) United States
(12) Patent Application Publication
(10) Pub. No.: US 2014/0009609 A1
(43) Pub. Date: Jan. 9, 2014

(54) VIDEO DOOR MONITOR USING SMARTTV WITH VOICE WAKEUP

(71) Applicant: Conexant Systems, Inc., Irvine, CA (US)

(72) Inventors: Andy B. Webster, Irvine, CA (US); Sailesh Chittipeddi, Tustin, CA (US); Michael Green, Westford, MA (US)

(21) Appl. No.: 13/935,413

(22) Filed: Jul. 3, 2013

Related U.S. Application Data
(60) Provisional application No. 61/668,973, filed on Jul. 6, 2012.

(51) Int. Cl. H04N 7/18

(52) U.S. Cl. CPC H04N 7/183
USPC 348/143

(57) ABSTRACT

A system for monitoring an entrance to a building comprising a door camera system for generating image data of a person at a predetermined location and a television system for displaying the image data, wherein the television system is configured to display the image data in coordination with a program.

### RELATED APPLICATIONS

This application claims benefit of U.S. Provisional Patent Application Ser. No. 61/668,973, filed Jul. 6, 2012, entitled “Video Door Monitor Using SmartTV with Voice Wakeup,” which is hereby incorporated by reference for all purposes, as if set forth herein in its entirety.

### TECHNICAL FIELD

The present disclosure relates to video door monitors, and more specifically to a video door monitor that can be used in conjunction with a television, such as a “smart” television having an internal processor and firmware, and that can utilize a voice/audio trigger and wakeup system to monitor for a door chime and to allow a viewer to converse with a person at a door of a building or residence.

### BACKGROUND OF THE INVENTION

Door monitors typically include a camera that is connected by a wireless or wire line connection to a dedicated monitor. While such systems allow a person, such as an occupant of a building, to see who is at a door to the building, they are dedicated systems that do not provide any alternate functionality.

### SUMMARY OF THE INVENTION

A system for monitoring an entrance to a building or residence is provided that can work in conjunction with an existing connected television set. The system includes a door camera system, such as a wireless door camera system, for generating image data of a person at a predetermined location, such as at a door to a building. A television system displays the image of the person in coordination with a program, such as by generating a picture-in-picture display of the person at the door.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for providing a wireless door monitor in accordance with an exemplary embodiment of the present disclosure;

FIG. 2 is a diagram of a system for providing door monitor functionality at a television set in accordance with an exemplary embodiment of the present invention;

FIG. 3 is a diagram of a system for providing a door camera system in accordance with an exemplary embodiment of the present disclosure; and

FIG. 4 is a diagram of an algorithm for controlling the operation of a door monitoring system, in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Existing wireless door monitors that allow a user to see and talk with persons at a doorway to a building require the use of dedicated display units that significantly add to the total cost of the monitor system. While televisions with wireless networking capabilities are available, a number of problems exist with the simple integration of such wireless door monitors to televisions through a wireless network. As a preliminary matter, the television is not always on, and using the wireless connection to continuously monitor signals received from the door monitor would continuously consume power even when the television is off, thus causing the television to fail to meet Energy Star® requirements for standby mode operation. As such, a person in the building would need to go turn on the television after hearing a door chime.

In addition, when the television is on and the door monitor camera is activated, a number of problems are presented. First, it would normally be necessary to reduce the volume of the television in order to enable a conversation with the person at the door. In addition, the ambient sound from the television will make it difficult or impossible for the person at the door to understand the person in the building.

The present disclosure allows a remote wireless door camera and wireless television to be connected to a home wireless network. When the television is on and the doorbell chime is activated, the television will display the video from the remote door camera in a small picture in picture window. Far field voice processing and acoustic echo cancellation on the audio input processor in the television is also used to enable two-way audio communication, without requiring the user to lower the volume on the television. In addition, the person at the door will only hear the person speaking and will not hear the audio from program playing on the television. In one exemplary embodiment, the television can implement facial recognition processing using a camera in the television to detect whether the user is watching the television, so as to allow the door bell chime to be disabled if the user is watching television.

When the television is off, television status data can be transmitted to the remote door camera, so when someone is at the door and presses the doorbell, the doorbell can be configured to generate a unique audio signal that can be detected by the microphone of the television in a standby mode of operation. In standby mode, the voice and audio trigger enabled television waits for a predetermined voice command, such that the audio input processor in the television can also be configured to recognize a predetermined doorbell audio signal that will cause it to wake up and display the image from the door camera.

In another exemplary embodiment, a control system, such as a remote control or voice recognition and control system of the television, in conjunction with the television door monitor system can be used to remotely unlock or open the door. In this exemplary embodiment, the door lock will include a controllable lock/unlock mechanism.

The present disclosure lowers the cost required to provide a video door monitor system because a dedicated display is not required, although a dedicated display can also or alternatively be used. The present disclosure also allows the television to be operated in a low power standby condition by detecting the door bell chime, using DSP processing to isolate and uniquely identify the door bell chime and to not falsely wake up from other sounds in the room. The present disclosure does not add any additional hardware costs to a television that has voice control, camera, facial recognition and a standby mode with voice command activated wake up. The present disclosure also improves the audio performance and audio quality of a video door monitor by using acoustic echo cancellation and far field pickup, for both inside and outside communications.

FIG. 1 is a diagram of a system 100 for providing a wireless door monitor in accordance with an exemplary embodiment of the present disclosure. System 100 includes television system 102, door camera system 104, wireless network 106 and door lock system 116, each of which can be implemented in hardware or a suitable combination of hardware and software.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Television system 102 includes acoustic echo canceller 108, door monitor system 110, camera and microphone system 112 and network interface 114. Acoustic echo canceller 108 performs acoustic echo cancellation, far field voice processing and other suitable audio signal processing on audio signals generated by camera and microphone system 112. In one exemplary embodiment, acoustic echo canceller 108 can subtract an audio signal generated by programming (such as programming provided from a digital cable media, a satellite media, an auxiliary device such as an optical, magnetic disk or memory device storage and playback media), such as from a signal that is being displayed on television system 102, from vocal audio signals, such as to allow a television viewer to converse with a person at the door of a building that is being monitored by door camera system 104. In this exemplary embodiment, the television viewer can continue to watch the programming while engaging in a conversation with the person at the door of the building. In another exemplary embodiment, door monitor system 110 can freeze the current programming to allow the viewer to converse with the person at the door without interrupting the current programming. Door monitor system 110 can also receive voice commands to either allow the current programming to continue or to freeze the current programming, can be programmed to either continue with programming or to freeze programming, or can perform other suitable functions. Door monitor system 110 can interface with door camera system 104 and door lock system 116 through wireless network 106 or in other suitable manners.

Door camera system 104 is disposed at a doorway, gate or other suitable location and can include one or more cameras, one or more microphones, one or more door chime buttons, motion sensors or other suitable systems and components to allow a person at a door of a building or in another suitable location to be detected and to allow video and audio data to be transmitted to television system 102, and to allow audio data to be transmitted to door camera system 104 from television system 102. Although one door camera system 104 is shown, a plurality of door camera systems 104 can also or alternatively be used.

Wireless network 106 can be implemented as a home wireless network, a cellular wireless network or other suitable wireless networks. Likewise, wireless network 106 can be replaced with a wire line network, can be implemented in conjunction with a wire line network or in other suitable manners so as to provide connectivity between the components of system 100.

Door monitor system 110 allows a door camera system 104 and door lock system 116 to be controlled from television system 102, such as by using voice commands, remote control commands, hand motions or in other suitable manners. In one exemplary embodiment, door monitor system 110 can include security systems for controlling access to door camera system 104 and door lock system 116, such as by transmitting and receiving communications from door camera system 104 and door lock system 116 using encrypted tokens or other suitable encryption, by responding to authentication requests or in other suitable manners. For example, encryption and authentication processes can be used that would not otherwise be implemented, such as using encryption keys based on user commands, user images or other suitable data, to prevent an external adversary from gaining control of door lock system 116 or other suitable systems. For example, a user can set a verbal password for door monitor system 110, which is then encrypted and stored by door lock system 116 and provided when a user wants to remotely open door lock system 116. The encrypted verbal password can then be decrypted and compared to a user-entered verbal password, so as to prevent an external adversary from being able to activate door lock system 116 from outside of the dwelling. Door monitor system 110 can generate picture-in-picture or full screen displays showing the person at the door, and can interface with other property monitor systems. Door monitor system 110 can also be configured to process speech signals to extract voice commands to select one of a plurality of cameras, to change the camera view (zoom in, zoom out, pan) and to perform other suitable functions.

Door lock system 116 can be implemented using a relay, an electronic or magnetic latching mechanism or in other suitable manners, so as to allow a lock on a door to be remotely controlled. In one exemplary embodiment, door lock system 116 can include encryption or other suitable security mechanisms to prevent door lock system 116 from being hacked or otherwise operated by unauthorized personnel. Although one door lock system 116 is shown, a plurality of door lock systems 116 can also or alternatively be used.

In operation, system 100 allows a television viewer to see a person at a door of a building or in other suitable locations, to interact with the person and to remotely unlock one or more doors. System 100 can use existing hardware solutions for wireless doorway monitoring and wireless lock control, and allows a viewer of a television to access the wireless doorway monitoring and wireless lock control systems without interrupting programming.

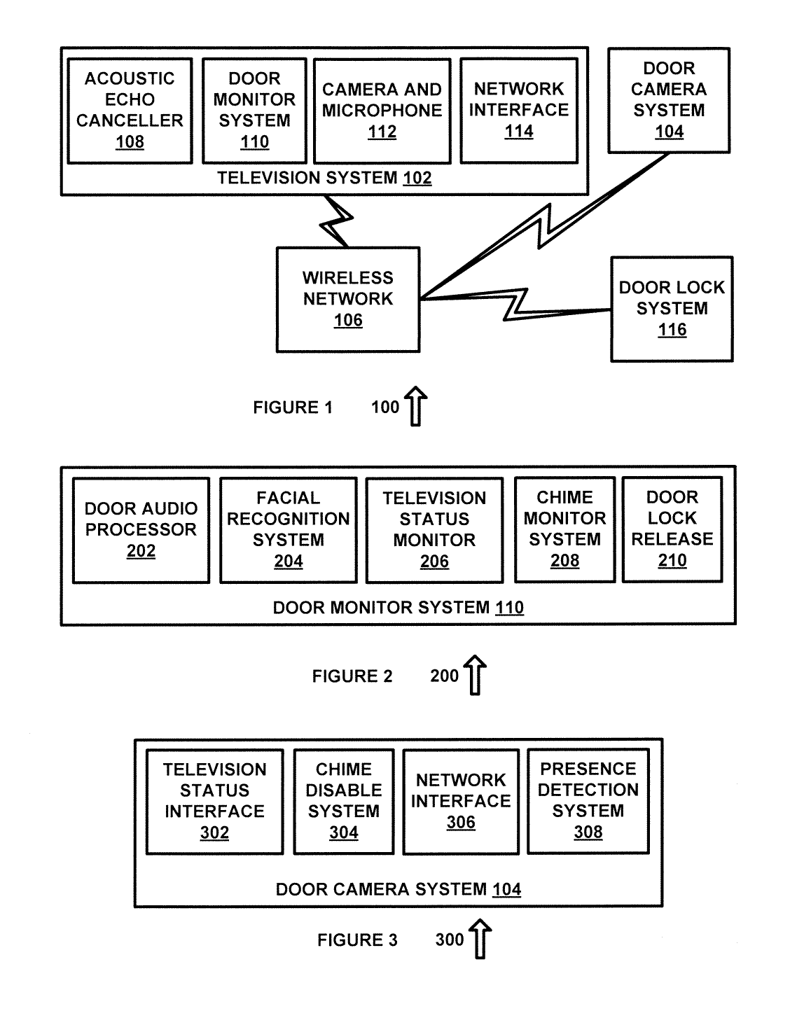

FIG. 2 is a diagram of a system 200 for providing door monitor functionality at a television set in accordance with an exemplary embodiment of the present invention. System 200 includes door monitor system 110 and door audio processor 202, facial recognition system 204, television status system 206, chime monitor system 208 and door lock release 210, each of which can be implemented in hardware or a suitable combination of hardware and software, and which can be one or more software systems operating on a television control processor.

Door audio processor 202 receives audio signals from a door camera system and generates audio signals from a viewer or other suitable persons to be transmitted to the door camera system. In one exemplary embodiment, door audio processor 202 can interface with a television audio system such as acoustic echo canceller 108 and can receive a program audio signal from the television audio system that is also being provided to the television speakers. Door audio processor 202 can also receive an audio signal from one or more microphones of the television system or television audio source, such as camera and microphone 112, and can perform acoustic echo cancellation, far field voice processing and other suitable processing on the microphone signals to subtract the program audio signal from the microphone signal, to perform acoustic echo cancellation and to otherwise process the microphone signal for transmission to the door camera system, so as to allow the viewer to converse with the person at the door camera system. Door audio processor 202 can also interface with the television audio system to control the volume of the audio signal from the door camera system, so as to prevent the need for the user to adjust a volume control and to accommodate for audio signals from the door camera system that are louder or softer than usual, such as when the person at the door camera system is standing near to or far from a microphone associated with the door camera system, is talking loudly or softly, or in other suitable situations. Door audio processor 202 can also perform automated speech processing to detect command words in speech signals, so as to allow a user to control system operation through spoken commands.

Facial recognition system 204 uses a camera associated with the television system to determine whether a viewer is present, such as to determine whether to generate an on screen display of a person at the door monitor system, to generate a chime, or to otherwise generate an indication that there is a person present at the door monitor system. In one exemplary embodiment, a television system may be on but there might not be a viewer present, such that an audible chime or other audible alert is generated to notify an occupant that there is a person present at a door of the building. Likewise, facial recognition system 204 can disable the audible chime or signal if it is determined that a viewer is present, can generate control data to cause an on-screen display to be generated, or can perform other suitable functions.

Television status system 206 generates television status data for use by a door camera system or other suitable systems. In one exemplary embodiment, when the television system is off or in standby mode, the door camera system, door chime system or other suitable systems can be enabled to generate an audible chime or other suitable signals to alert an occupant that there is a person at a door of the building or in other suitable locations.

Chime monitor system 208 provides audio monitoring functionality to detect a door chime or other suitable signals. In one exemplary embodiment, an existing doorbell or other suitable systems may be present to allow a person at a door of a building to indicate that they are present. Likewise, chime monitor system 208 can be configured to detect a knock at a door or other suitable sounds, such as by processing audio data with a digital signal processor that has stored knock audio profile data or by using a training procedure, can be configured to cause the television system to go from an off or standby mode to an active mode, so as to generate a video image from the door camera system, or can be configured to perform other suitable systems.

Door lock release 210 allows a user to generate a door unlock control to unlock a door. In one exemplary embodiment, the door can have a lock with an associated door lock system that has a relay, an electric or magnetic lock or other suitable locking or unlocking devices, where the door remains locked until a door unlock control is received, or until the lock is manually operated. In another exemplary embodiment, door lock release 210 can also be used to lock a door, such as where an entrance to a building includes a space accessed by a first unlocked door and a second locked door, such as to allow an intruder to be locked into the space and to be detained until police or other security personnel arrive.

In operation, system 200 allows a television to be used to interface with a door camera system, a door lock system and other suitable systems, to allow a viewer to see who is at a door without interrupting programming, to notify an occupant that a person is at the door when the television is off, and to perform other suitable functions.

FIG. 3 is a diagram of a system 300 for providing door camera system in accordance with an exemplary embodiment of the present disclosure. System 300 includes door camera system 104 and television status interface 302, chime disable system 304, network interface 306 and presence detection system 308, each of which can be implemented in hardware or a suitable combination of hardware and software and which can be one or more software systems operating on a processor.

Television status interface 302 receives television status data, such as to allow system 300 to determine whether a television is on or not. In one exemplary embodiment, when television status data indicates that the television is on, a door chime can be disabled, such as when a viewer is also present and watching the television. In another exemplary embodiment, television status data can indicate that there is no viewer present even when a television is on, such that the chime remains enabled.

Chime disable system 304 controls a door chime, such as to disable the door chime when a viewer is watching television and receives an on-screen notification that a person is present at system 300.

Network interface 306 allows system 300 to interface with a wireless network, a wire line network or other suitable networks. In one exemplary embodiment, network interface 306 can interface with a home wireless network, such as an 802.xx wireless network, a cellular wireless network, an Ethernet wire line network, a power line data network, or other suitable wireless or wire line networks.

Presence detection system 308 can detect when a person is present at system 300. In one exemplary embodiment, presence detection system 308 can use facial recognition (either locally or remotely, such as at a television system), infrared detectors, video motion detectors, weight detectors or other suitable mechanisms to detect when a person is at a door to a building or in other suitable locations, and to generate a suitable signal, such as a digital or analog electrical signal, a digital or analog wireless signal or other suitable signals that can be received and processed by door monitor system 110 or other suitable systems.

In operation, system 300 allows a door camera system to interface with a television system, to allow the door camera system to transmit audio and video data to the television system and to allow system 300 to generate audio signals received from the television system on one or more speakers. Door camera system can also include one or more microphones, one or more cameras and other suitable components.

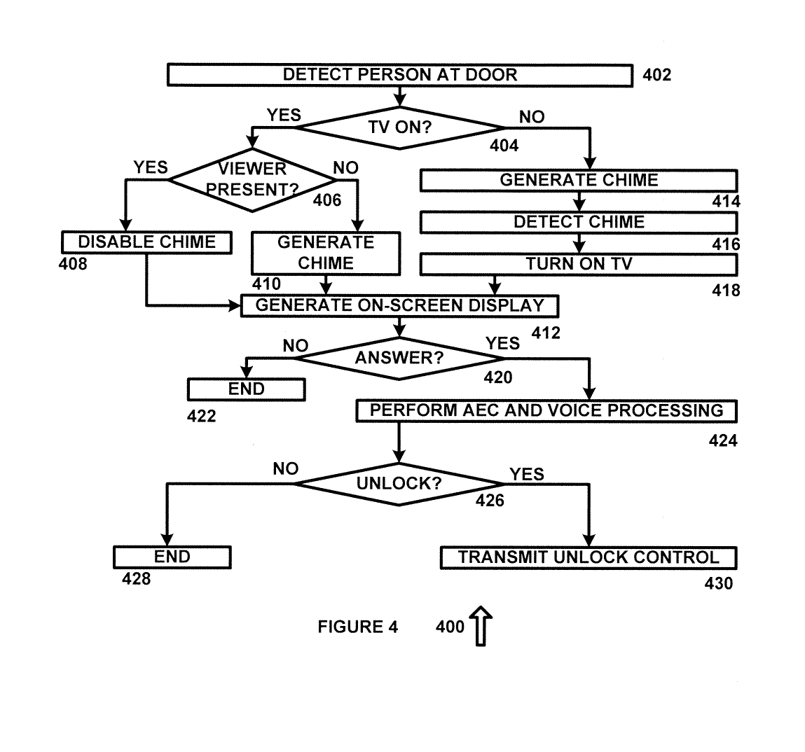

FIG. 4 is a diagram of an algorithm 400 for controlling the operation of a door monitoring system, in accordance with an exemplary embodiment of the present disclosure. Algorithm 400 can be implemented in hardware or a suitable combination of hardware and software, such as one or more software systems operating on one or more processors.

Algorithm 400 begins at 402, where a person is detected at a door. In one exemplary embodiment, facial recognition algorithms (either locally at a door monitor system or remotely, such as at a television system), infrared detector monitoring algorithms, motion detector algorithms, weight detector monitor algorithms or other suitable algorithms can generate data that indicates that a person has been detected, such as one or more bits of data having a predetermined format. The detection data can be transmitted to a detection system operating on a processor at a television or to other suitable systems. The algorithm then proceeds to 404.

At 404, it is determined whether a television system is on. In one exemplary embodiment, television status data stored in a data register can be checked to determine whether the status data indicates that the television system is off or in standby mode, whether the status data indicates that the television system is on but where no viewer is present, or other suitable status data can be checked, such as by sending a request to a television system and determining whether a response has been received. If it is determined that the television system is on, the algorithm proceeds to 406, otherwise, the algorithm proceeds to 414.

At 406, it is determined whether a viewer is present, if the determination has not been previously performed, such as by processing image data from a camera system of the television system with a facial recognition algorithm or in other suitable manners. If it is determined that a viewer is present, the algorithm proceeds to 408 and an audible chime is disabled, such as to prevent the chime from sounding and interrupting programming on the television. The algorithm then proceeds to 412. Otherwise, the algorithm proceeds to 410 where an audible chime is generated, such as to alert an occupant that a person is at a door of the building, so the occupant can use the television system to view the person at the door. The algorithm then proceeds to 412.

If it is determined at 404 that the television is not on, the algorithm proceeds to 414, where a chime is generated. In one exemplary embodiment, the chime can be generated by the door monitor system. Alternatively, the chime can be generated by activation of a doorbell control by the person at the door or in other suitable manners. The algorithm then proceeds to 416, where the chime is detected. In one exemplary embodiment, a standby audio processor system of the television system can monitor audio signals for voice commands, for predetermined chime audio signals, or for other suitable audio data. The algorithm then proceeds to 418, where the television system is turned on, is transitioned from a standby mode to an active mode, or other suitable processes can be performed. The algorithm then proceeds to 412.

At 412, an on screen display is generated at the television system. In one exemplary embodiment, the on screen display can be a picture-in-picture display where the current programming continues without interruption. In another exemplary embodiment, the current programming can be stopped and the on screen display can be a full screen display. In another exemplary embodiment, programming, voice commands, remote control commands or other suitable controls can be used to change from a picture-in-picture display to a full screen display, to allow the camera image to zoom in to the face of the person at the door or to zoom out to a selected field of view, other cameras can also or alternatively be viewed (such as perimeter, interior or exterior cameras), or other suitable controls can be provided. The algorithm then proceeds to 412.

At 412, it is determined whether an answer should be transmitted to the door camera system. In one exemplary embodiment, voice commands, remote control commands or other suitable commands can be received and processed, a default setting can be used or other suitable commands or programming can be used to determine whether an answer should be transmitted. If it is determined that an answer should not be transmitted, the algorithm proceeds to 422 and terminates, such as by discontinuing the generation of the audio and video data being received from the camera system, by playing a recorded message that informs the person at the door camera system that the occupants do not want to be disturbed, or in other suitable manners. Otherwise, the algorithm proceeds to 424, where audio communication with the door camera system is enabled and acoustic echo cancellation, far field voice processing and other suitable audio processing is performed. In one exemplary embodiment, the audio processing can be used to cancel out audio signals from programming on the television set, to adjust the audio signal from the door camera system (such as to amplify or reduce the audio signal), or to perform other suitable functions. The algorithm then proceeds to 426.

At 426, it is determined whether an unlock control should be generated. In one exemplary embodiment, voice commands, remote control commands or other suitable controls can be used to generate control data for a door lock mechanism, including encryption, authentication or other suitable security processes that are used to prevent the door lock mechanism from being activated or deactivated by unauthorized personnel. In another exemplary embodiment, a determination to activate a second door lock can be made, as previously described, or other suitable determinations can be made at 426. If it is determined that the door should not be unlocked or that no other actions should be taken, the algorithm proceeds to 428 and terminates. Otherwise, the algorithm proceeds to 430, where the unlock control data or other suitable control data is generated and transmitted.

In operation, algorithm 400 allows a door monitor system to alert an occupant or other suitable persons such as monitoring personnel at a remote site that a person is at a door of a building, and further allows the occupant, viewer or other suitable personnel to communicate with the person at the door. In this manner, a door camera system can be accessed by a television viewer without interrupting programming or other suitable processes can be performed.

Although the exemplary embodiments described above include a television system, a dedicated door monitor can also or alternatively be used.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for monitoring an entrance to a building comprising:
a door camera system configured to generate image data of a person at a predetermined location;
a television system configured to display the image data, wherein the television system is further configured to display the image data in coordination with image data from programming that is being shown on the television system and without interrupting the programming that is being shown on the television system.

2. The system of claim 1 wherein the television system further comprises a door monitor system configured to generate a picture-in-picture image of the person at the predetermined location without interrupting the programming that is being shown on the television system.

3. The system of claim 1 further comprising a door audio processor configured to perform acoustic echo cancellation audio processing of an audio signal generated by a microphone of the television system.

4. The system of claim 1 further comprising a door audio processor configured to perform audio processing of an audio signal generated by the door camera system to adjust the door camera audio signal to a predetermined level at the television.

5. The system of claim 1 further comprising a facial recognition system configured to determine whether a viewer is present, and activate a chime generator if it is determined that a viewer is not present.

6. The system of claim 1 further comprising a television status monitor configured to generate television status control to activate a chime generator if the television is in standby or inactive mode.

7. The system of claim 1 further comprising a chime monitor system configured to monitor an audio signal generated by a microphone of the television system to determine whether a chime has been detected and to generate control data to cause the television to transition from a standby or inactive mode to an active mode to display the image data of the person at the predetermined location.

8. The system of claim 1 further comprising a door lock release system configured to generate door lock release control data in response to a door lock release command from a user.

9. A method for monitoring an entrance to a building comprising:
determining whether a television is active and displaying programming;
generating a display showing a person at a predetermined location in conjunction with the programming if the television is active and displaying the programming; and
transitioning the television from an inactive or standby mode to active mode to generate the display showing the person at the predetermined location of it is determined that the television is not active.

10. The method of claim 9 wherein generating the display showing the person at the predetermined location in conjunction with the programming if the television is active and displaying the programming comprises generating a picture-in-picture display within the programming.

11. The method of claim 9 wherein generating the display showing the person at the predetermined location in conjunction with the programming if the television is active and displaying the programming comprises freezing the programming and replacing the programming with the display showing the person at the predetermined location.

12. The method of claim 9 further comprising performing processing of an audio signal received from a microphone of the television to remove an audio signal of the television program or video source from the microphone audio signal.

13. The method of claim 9 further comprising:
receiving a command at the television to generate an unlock control; and
transmitting the unlock control to a door lock system.

14. The method of claim 9 further comprising:
receiving a first audio signal from a microphone of the television;
receiving a second audio signal associated with the programming; and
processing the first audio signal to cancel the second audio signal.

15. A system for monitoring an entrance to a building comprising:
a door camera system configured to generate image data of a person at a predetermined location;
a television system configured to display the image data, wherein the television system is configured to transition from a stand-by state to an active state to display the image data.

16. The system of claim 15 further comprising a door audio processor configured to perform audio processing of an audio signal generated by the door camera system to adjust the door camera audio signal to a predetermined level at the television.

17. The system of claim 15 further comprising a facial recognition system configured to determine whether a viewer is present, and activate a chime generator if it is determined that a viewer is not present.

18. The system of claim 15 further comprising a television status monitor configured to generate television status control to activate a chime generator if the television is in standby or inactive mode.

19. The system of claim 15 further comprising a chime monitor system configured to monitor an audio signal generated by a microphone of the television system to determine whether a chime has been detected and to generate control data to cause the television to transition from the stand-by state to the active state to display the image data of the person at the predetermined location.

20. The system of claim 15 further comprising a door lock release system configured to generate door lock release control data in response to a door lock release command from a user at the television system.
